(19) United States
(12) Patent Application Publication
(10) Pub. No.: US 2011/0055838 A1
(43) Pub. Date: Mar. 3, 2011

(54) OPTIMIZED THREAD SCHEDULING VIA HARDWARE PERFORMANCE MONITORING

(76) Inventor: William A. Moyes, Austin, TX (US)

(21) Appl. No.: 12/549,701

(22) Filed: Aug. 28, 2009

(51) Int. Cl. G06F 9/46

(52) U.S. Cl. 718/102

(57) ABSTRACT

A system and method for efficient dynamic scheduling of tasks. A scheduler within an operating system assigns software threads of program code to computation units. A computation unit may be a microprocessor, a processor core, or a hardware thread in a multi-threaded core. The scheduler receives measured data values from performance monitoring hardware within a processor as the one or more processors execute the software threads. The scheduler may be configured to reassign a first thread assigned to a first computation unit coupled to a first shared resource to a second computation unit coupled to a second shared resource. The scheduler may perform this dynamic reassignment in response to determining from the measured data values a first measured value corresponding to the utilization of the first shared resource exceeds a predetermined threshold and a second measured value corresponding to the utilization of the second shared resource does not exceed the predetermined threshold.

### BACKGROUND OF THE INVENTION

1. Field of the Invention

This invention relates to computing systems, and more particularly, to efficient dynamic scheduling of tasks.

2. Description of the Relevant Art

Modern microprocessors execute multiple threads simultaneously in order to take advantage of instruction-level parallelism. In addition, to further the effort, these microprocessors may include hardware for multiple-instruction issue, dispatch, execution, and retirement; extra routing and logic to determine data forwarding for multiple instructions simultaneously per clock cycle; intricate branch prediction schemes, simultaneous multi-threading; and other design features. These microprocessors may have two or more threads competing for a shared resource such as an instruction fetch unit (IFU), a branch prediction unit, a floating-point unit (FPU), a store queue within a load-store unit (LSU), a common data bus transmitting results of executed instructions, or other.

Also, a microprocessor design may replicate a processor core multiple times in order to increase parallel execution of the multiple threads of software applications. In such a design, two or more cores may compete for a shared resource, such as a graphics processing unit (GPU), a level-two (L2) cache, or other resource, depending on the processing needs of corresponding threads. Further still, a computing system design may instantiate two or more microprocessors in order to increase throughput. However, two or more microprocessors may compete for a shared resource, such as an L2 or L3 cache, a memory bus, an input/output (I/O) device.

Each of these designs is typically pipelined, wherein the processor cores include one or more data processing stages connected in series with storage elements (e.g. registers and arrays) placed between the stages. Ideally, every clock cycle produces useful execution of an instruction for each stage of a pipeline. However, a stall in a pipeline may cause no useful work to be performed during that particular pipeline stage.

One example of a cause of a stall is shared resource contention. Resource contention may typically cause a multi-cycle stall. Resource contention occurs when a number of computation units requesting access to a shared resource exceeds a number of units that the shared resource may support for simultaneous access. A computation unit may be a hardware thread, a processor core, a microprocessor, or other. A computation unit that is seeking to utilize a shared resource, but is not granted access, may need to stall. The duration of the stall may depend on the time granted to one or more other computation units currently accessing the shared resource. This latency, which may be expressed as the total number of processor cycles required to wait for shared resource access, is growing as computing system designs attempt to have greater resource sharing between computation units. The stalls resulting from resource contention reduce the benefit of replicating cores or other computation units capable of multi-threaded execution.

Software within an operating system known as a scheduler typically performs the scheduling, or assignment, of software processes, and their corresponding threads, to processors. The decision logic within schedulers may take into consideration processor utilization, the amount of time to execute a particular process, the amount of time a process has been waiting in a ready queue, and equal processing time for each thread among other factors.

However, modern schedulers use fixed non-changing descriptions of the system to assign tasks, or threads, to compute resources. These descriptions fail to take into consideration the dynamic behavior of the task itself. For example, a pair of processor cores, core1 and core2, may share a single floating point unit (FPU), arbitrarily named FPU1. A second pair of processor cores, core3 and core4, may share a second FPU named FPU2. Processes and threads may place different demands on these resources. A first thread, thread1, may be assigned to core1 At this time, it may not be known that thread1 heavily utilizes a FPU due to a high number of floating-point instructions. A second thread, thread2, may be assigned to core3 in order to create minimal potential contention between core1 and core3 due to minimum resource sharing. At this time, it may not be known that thread2 is not an FPU intensive thread.

When a third thread, thread3, is encountered, the scheduler may assign thread3 to core2, since it is the next available computation unit. At this time, it may not be known is that thread3 heavily utilizes a FPU by also comprising a high number of floating-point instructions. Now, since both thread1 and thread3 heavily utilize a FPU, resource contention will occur on FPU1 as the threads execute. Accordingly, system throughput may decrease from this non-optimal assignment by the scheduler. Typically, scheduling is based upon fixed rules for assignment and these rules do not consider the run-time behavior of the plurality of threads in the computing system. A limitation of this approach is the scheduler does not consider the current behavior of the thread when assigning threads to computation units that contend for a shared resource.

In view of the above, efficient methods and mechanisms for efficient dynamic scheduling of tasks are desired.

### SUMMARY OF THE INVENTION

Systems and methods for efficient scheduling of tasks are contemplated.

In one embodiment, a computing system comprises one or more microprocessors comprising performance monitoring hardware, a memory coupled to the one or more microprocessors, wherein the memory stores a program comprising program code, and a scheduler located in an operating system. The scheduler is configured to assign a plurality of software threads corresponding to the program code to a plurality of computation units. A computation unit may, for example, be a microprocessor, a processor core, or a hardware thread in a multi-threaded core. The scheduler receives measured data values from the performance monitoring hardware as the one or more microprocessors process the software threads of the program code. The scheduler may be configured to reassign a first thread assigned to a first computation unit coupled to a first shared resource to a second computation unit coupled to a second shared resource. The scheduler may perform this dynamic reassignment in response to determining from the measured data values that a first value corresponding to the utilization of the first shared resource exceeds a predetermined threshold and a second value corresponding to the utilization of the second shared resource does not exceed the predetermined threshold.

These and other embodiments will become apparent upon reference to the following description and accompanying drawings.

### BRIEF DESCRIPTION OF THE DRAWINGS

FIG. 1 is a generalized block diagram illustrating one embodiment of a processing subsystem.

FIG. 2 is a generalized block diagram of one embodiment of a general-purpose processor core.

FIG. 3 is a generalized block diagram illustrating one embodiment of hardware and software thread assignments.

FIG. 4 is a generalized block diagram illustrating one embodiment of hardware measurement data used in an operating system.

FIG. 5 is a flow diagram of one embodiment of a method for efficient dynamic scheduling of tasks.

While the invention is susceptible to various modifications and alternative forms, specific embodiments are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the spirit and scope of the present invention as defined by the appended claims.

### DETAILED DESCRIPTION

In the following description, numerous specific details are set forth to provide a thorough understanding of the present invention. However, one having ordinary skill in the art should recognize that the invention may be practiced without these specific details. In some instances, well-known circuits, structures, and techniques have not been shown in detail to avoid obscuring the present invention.

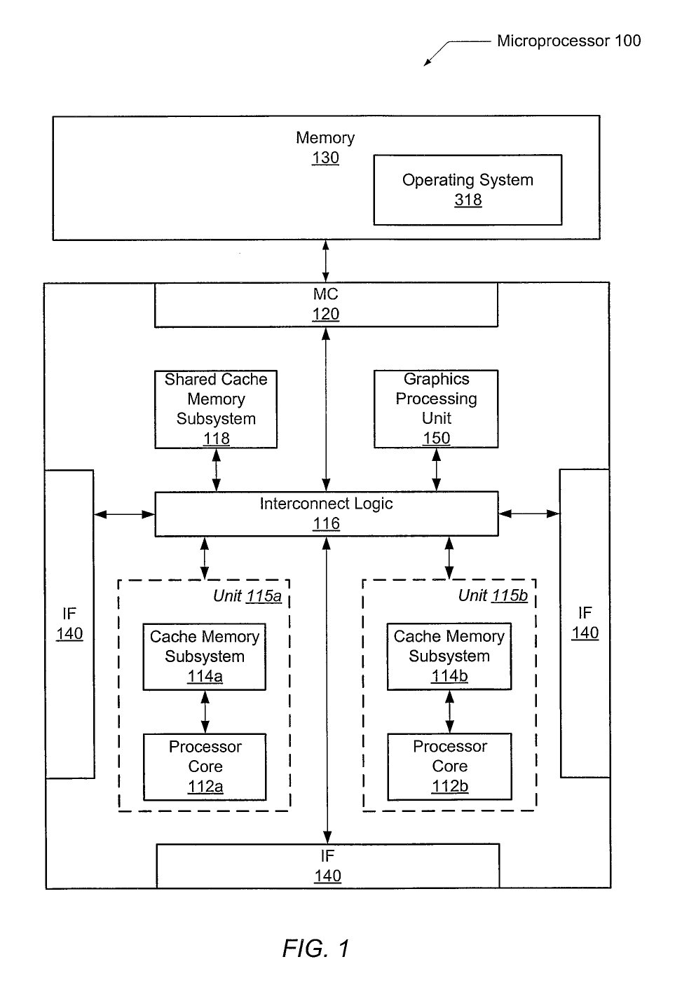

Referring to FIG. 1, one embodiment of an exemplary microprocessor 100 is shown. Microprocessor 100 may include memory controller 120 coupled to memory 130, interface logic 140, one or more processing units 115, which may include one or more processor cores 112 and corresponding cache memory subsystems 114; crossbar interconnect logic 116, a shared cache memory subsystem 118, and a shared graphics processing unit (GPU) 150. Memory 130 is shown to include operating system code 318. It is noted that various portions of operating system code 318 may be resident in memory 130, in one or more caches (114, 118), stored on a non-volatile storage device such as a hard disk (not shown), and so on. In one embodiment, the illustrated functionality of microprocessor 100 is incorporated upon a single integrated circuit.

Interface 140 generally provides an interface for input/output (I/O) devices off the microprocessor 100 to the shared cache memory subsystem 118 and processing units 115. As used herein, elements referred to by a reference numeral followed by a letter may be collectively referred to by the numeral alone. For example, processing units 115a-115b may be collectively referred to as processing units 115, or units 115. I/O devices may include peripheral network devices such as printers, keyboards, monitors, cameras, card readers, hard or floppy disk drives or drive controllers, network interface cards, video accelerators, audio cards, modems, a variety of data acquisition cards such as General Purpose Interface Bus (GPIB) or field bus interface cards, or other. These I/O devices may be shared by each of the processing units 115 of microprocessor. Additionally, these I/O devices may be shared by processing units 115 in other microprocessors.

Also, interface 140 may be used to communicate with these other microprocessors and/or other processing nodes. Generally, interface logic 140 may comprise buffers for receiving packets from a corresponding link and for buffering packets to be transmitted upon the a corresponding link. Any suitable flow control mechanism may be used for transmitting packets to and from microprocessor 100.

Microprocessor 100 may be coupled to a respective memory via a respective memory controller 120. Memory may comprise any suitable memory devices. For example, a memory may comprise one or more RAMBUS dynamic random access memories (DRAMs), synchronous DRAMs (SDRAMs), DRAM, static RAM, etc. The address space of microprocessor 100 may be divided among multiple memories. Each microprocessor 100 or a respective processing node comprising microprocessor 100 may include a memory map used to determine which addresses are mapped to which memories, and hence to which microprocessor 100 or processing node a memory request for a particular address should be routed. In one embodiment, the coherency point for an address is the memory controller 120 coupled to the memory storing bytes corresponding to the address. Memory controllers 120 may comprise control circuitry for interfacing to memories. Additionally, memory controllers 120 may include request queues for queuing memory requests.

Generally speaking, crossbar interconnect logic 116 is configured to respond to received control packets received on the links coupled to Interface 140, to generate control packets in response to processor cores 112 and/or cache memory subsystems 114, to generate probe commands and response packets in response to transactions selected by memory controller 120 for service, and to route packets for an intermediate node which comprises microprocessor to other nodes through interface logic 140. Interface logic 140 may include logic to receive packets and synchronize the packets to an internal clock used by crossbar interconnect 116. Crossbar interconnect 116 may be configured to convey memory requests from processor cores 112 to shared cache memory subsystem 118 or to memory controller 120 and the lower levels of the memory subsystem. Also, crossbar interconnect 116 may convey received memory lines and control signals from lower-level memory via memory controller 120 to processor cores 112 and caches memory subsystems 114 and 118. Interconnect bus implementations between crossbar interconnect 116, memory controller 120, interface 140, and processor units 115 may comprise any suitable technology.

Cache memory subsystems 114 and 118 may comprise high speed cache memories configured to store blocks of data. Cache memory subsystems 114 may be integrated within respective processor cores 112. Alternatively, cache memory subsystems 114 may be coupled to processor cores 112 in a backside cache configuration or an inline configuration, as desired. Still further, cache memory subsystems 114 may be implemented as a hierarchy of caches. Caches, which are nearer processor cores 112 (within the hierarchy), may be integrated into processor cores 112, if desired. In one embodiment, cache memory subsystems 114 each represent L2 cache structures, and shared cache subsystem 118 represents an L3 cache structure.

Both the cache memory subsystem 114 and the shared cache memory subsystem 118 may include a cache memory coupled to a corresponding cache controller. Processor cores 112 include circuitry for executing instructions according to a predefined general-purpose instruction set. For example, the ×86 instruction set architecture may be selected. Alternatively, the Alpha, PowerPC, or any other general-purpose instruction set architecture may be selected. Generally, processor core 112 accesses the cache memory subsystems 114, respectively, for data and instructions. If the requested block is not found in cache memory subsystem 114 or in shared cache memory subsystem 118, then a read request may be generated and transmitted to the memory controller 120 en route to the location to which the missing block is mapped. Processor cores 112 are configured to simultaneously execute one or more threads. If processor cores 112 are configured to execute two or more threads, the multiple threads of a processor core 112 shares a corresponding cache memory subsystem 114. The plurality of threads executed by processor cores 112 share at least the shared cache memory subsystem 118, the graphics processing unit (GPU) 150, and the coupled I/O devices.

The GPU 150 may include one or more graphic processor cores and data storage buffers dedicated to a graphics rendering device for a personal computer, a workstation, or a video game console. A modern GPU 150 may have a highly parallel structure makes it more effective than general-purpose processor cores 112 for a range of is complex algorithms. A GPU 150 executes calculations required for graphics and video and the CPU executes calculations for many more system processes than graphics alone. In one embodiment, a GPU 150 may be incorporated upon a single integrated circuit as shown in microprocessor 100. In another embodiment, the GPU 150 may be integrated on the motherboard. In yet another embodiment, the functionality of GPU 150 may be integrated on a video card. In such an embodiment, microprocessor 100 and GPU 150 may be proprietary cores from different design centers. Also, the GPU 150 may now be able to directly access both local memories 114 and 118 and main memory via memory controller 120, rather than perform memory accesses off-chip via interface 140.

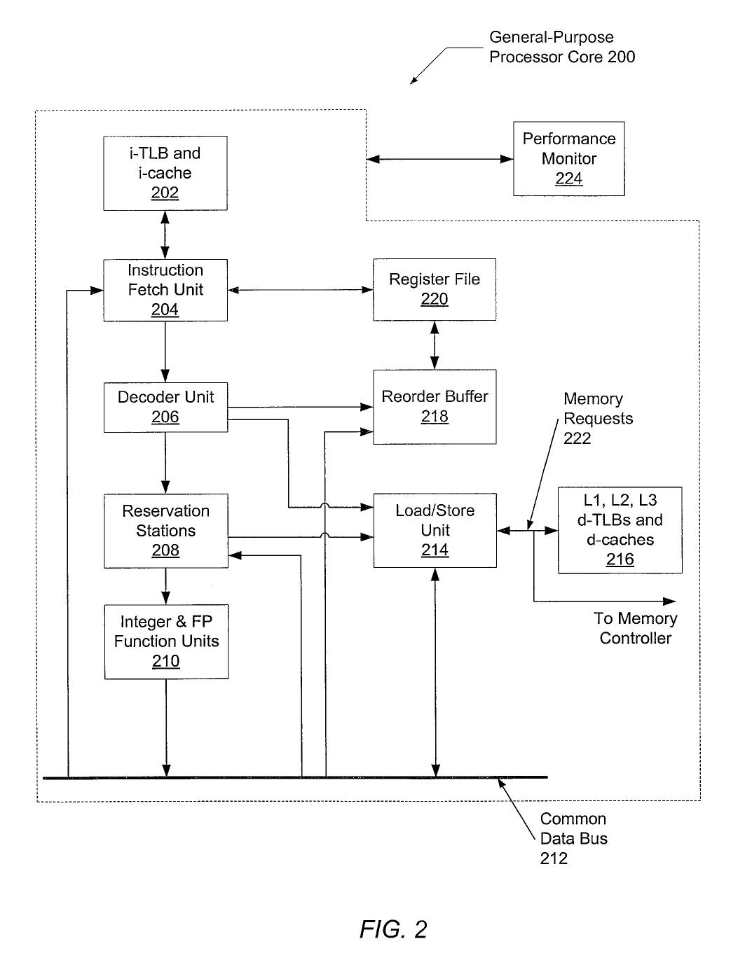

Turning now to FIG. 2, one embodiment of a general-purpose processor core 200 that performs out-of-order execution is shown. In one embodiment, processor core 200 is configured to simultaneously process two or more threads. An instruction-cache (i-cache) and corresponding translation-lookaside-buffer (TLB) 202 may store instructions for a software application and addresses in order to access the instructions. The instruction fetch unit (IFU) 204 may fetch multiple instructions from the i-cache 202 per clock cycle if there are no i-cache misses. The IFU 204 may include a program counter that holds a pointer to an address of the next instructions to fetch in the i-cache 202, which may be compared to addresses in the i-TLB. The IFU 204 may also include a branch prediction unit to predict an outcome of a conditional instruction prior to an execution unit determining the actual outcome in a later pipeline stage.

The decoder unit 206 decodes the opcodes of the multiple fetched instructions and may allocate entries in an in-order retirement queue, such as reorder buffer 218, in reservation stations 208, and in a load/store unit 214. The allocation of entries in the reservation stations 208 is considered dispatch. The reservation stations 208 may act as an instruction queue where instructions wait until their operands become available. When operands are available and hardware resources are also available, an instruction may be issued out-of-order from the reservation stations 208 to the integer and floating-point functional units 210 or to the load/store unit 214.

Memory accesses such as load and store operations are issued to the load/store unit (LSU) 214. The functional units 210 may include arithmetic logic units (ALU's) for computational calculations such as addition, subtraction, multiplication, division, and square root. Logic may be included to determine an outcome of a conditional instruction. The load/store unit 214 may include queues and logic to execute a memory access instruction. Also, verification logic may reside in the load/store unit 214 to ensure a load instruction receives forwarded data from the correct youngest store instruction.

The load/store unit 214 may send memory access requests 222 to the one or more levels of data cache (d-cache) 216 on the chip. Each level of cache may have its own TLB for address comparisons with the memory requests 222. Each level of cache 216 may be searched in a serial or parallel manner. If the requested memory line is not found in the caches 216, then a memory request 222 is sent to the memory controller in order to access the memory line in system memory off-chip. The serial or parallel searches, the possible request to the memory controller, and the wait for the requested memory line to arrive may require a substantial number of clock cycles.

Results from the functional units 210 and the load/store unit 214 may be presented on a common data bus 212. The results may be sent to the reorder buffer 218. In one embodiment, the reorder buffer 218 may be a first-in first-out (FIFO) queue that ensures in-order retirement of instructions according to program order. Here, an instruction that receives its results is marked for retirement. If the instruction is head-of-the-queue, it may have its results sent to the register file 220. The register file 220 may hold the architectural state of the general-purpose registers of processor core 200. Then the instruction in the reorder buffer may be retired in-order and its head-of-queue pointer may be adjusted to the subsequent instruction in program order.

The results on the common data bus 212 may be sent to the reservation stations 208 in order to forward values to operands of instructions waiting for the results. For example, an arithmetic instruction may have operands that depend on the results of a previous arithmetic instruction, or a load instruction may need an address calculated by an address generation unit (AGU) in the functional units 210. When these waiting instructions have values for their operands and hardware resources are available to execute the instructions, they may be issued out-of-order from the reservation stations 208 to the appropriate resources in the functional units 210 or the load/store unit 214.

Uncommitted, or non-retired, memory access instructions have entries in the load/store unit. The forwarded data value for an in-flight, or uncommitted, load instruction from the youngest uncommitted older store instruction may be placed on the common data bus 112 or simply routed to the appropriate entry in a load buffer within the load/store unit 214. In one embodiment, as stated earlier, processor core 200 is configured to simultaneously execute two or more threads. Multiple resources within core 200 may be shared by this plurality of threads. For example, these threads may share each of the blocks 202-216 shown in FIG. 2. Certain resources, such as a floating-point unit (FPU) within function unit 210 may have only a single instantiation in core 200. Therefore, resource contention may increase if two or more threads include instructions that are floating-point intensive.

Performance monitor 224 may include dedicated measurement hardware for recording and reporting performance metrics corresponding to the design and operation of processor core 200. Performance monitor 224 is shown located outside of the processing blocks 202-216 of processor core 200 for illustrative purposes. The hardware of monitor 224 may be integrated throughout the floorplan of core 200. Alternatively, portions of the performance monitor 224 may reside both within and without core 200. All such combinations are contemplated. The hardware of monitor 224 may collect data as fine-grained as required to assist tuning and understanding the behavior of software applications and hardware resource utilization. Additionally, events that may be unobservable or inconvenient to measure in software, such as peak memory contention or response time to invoke an interrupt handler, may be performed effectively in hardware. Consequently, hardware in performance monitor 224 may expand the variety and detail of measurements available with little or no impact on application performance. Based upon information provided by the performance monitor 224, software designers may modify applications, a compiler, or both.

In one embodiment, monitor 224 may include one or more multi-bit registers which may be used as hardware performance counters capable of counting a plurality of predetermined events, or hardware-related activities. Alternatively, the counters may count the number of processor cycles spent performing predetermined events. Examples of events may include pipeline flushes, data cache snoops and snoop hits, cache and TLB misses, read and write operations, data cache lines written back, branch operations, taken branch operations, the number of instructions in an integer or floating-point pipeline, and bus utilization. Several other events well known in the art are possible and contemplated. In addition to storing absolute numbers corresponding to hardware-related activities, the performance monitor 224 may determine and store relative numbers, such as a percentage of cache read operations that hit in a cache.

In addition to the hardware performance counters, monitor 224 may include a timestamp counter, which may be used for accurate timing of routines. A time stamp counter may also used to determine a time rate, or frequency, of hardware-related activities. For example, the performance monitor 224 may determine, store, and update a number of cache read operations per second, a number of pipeline flushes per second, a number of floating-point operations per second, or other.

In order for the hardware-related performance data to be accessed, such as by an operating system or a software programmer, in one embodiment, performance monitor 224 may include monitoring output pins. The output pins may, for example, be configured to toggle after a predetermined event, a counter overflow, pipeline status information, or other. By wiring one of these pins to an interrupt pin, software may be reactive to performance data.

In another embodiment, specific instructions may be included in an instruction set architecture (ISA) in order to disable and enable data collection, respectively, and to read one or more specific registers. In some embodiments, kernel-level support is needed to access registers in performance monitor 224. For example, a program may need to be in supervisor mode to access the hardware of performance monitor 224, which may require a system call. A performance monitoring driver may also be developed for a kernel.

In yet another embodiment, an operating system may provide one or more application programming interfaces (APIs) corresponding to the processor hardware performance counters. A series of APIs may be available as shared libraries in order to program and access the various hardware counters. Also, the APIs may allow configurable threshold values to be programmed corresponding to data measured by the performance monitor 224. In addition, an operating system may provide similar libraries to program and access the hardware counters of a system bus and input/output (I/O) boards. In one embodiment, the libraries including these APIs may be used to instrument application code to access the performance hardware counters and collect performance information.

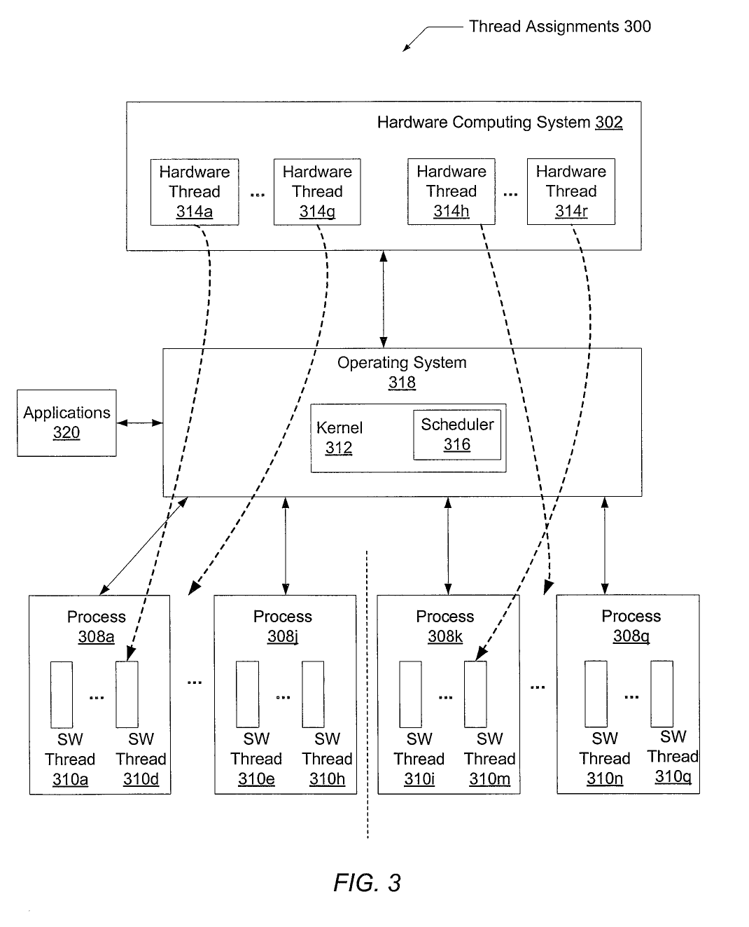

FIG. 3 illustrates one embodiment of hardware and software thread interrelationships 300. Here, the partitioning of hardware and software resources and their interrelationships and assignments during the execution of one or more software applications 320 is shown. In one embodiment, an operating system 318 allocates regions of memory for processes 308. When applications 320, or computer programs, execute, each application may comprise multiple processes, such as Processes 308a-308j and 308k-308q. In such an embodiment, each process 308 may own its own resources such as an image of memory, or an instance of instructions and data before application execution. Also, each process 308 may comprise process-specific information such as address space that addresses the code, data, and possibly a heap and a stack; variables in data and control registers such as stack pointers, general and floating-point registers, program counter, and otherwise; and operating system descriptors such as stdin, stdout, and otherwise, and security attributes such as processor owner and the process' set of permissions.

Within each of the processes 308 may be one or more software threads. For example, Process 308a comprises software (SW) Threads 310a-310d. A thread can execute independent of other threads within its corresponding process and a thread can execute concurrently with other threads within its corresponding process. Generally speaking, each of the threads 310 belongs to only one of the processes 308. Therefore, for multiple threads of the same process, such as SW Thread 310a-310d of Process 308a, the same data content of a memory line, for example the line of address 0×ff38, may be the same for all threads. This assumes the inter-thread communication has been made secure and handles the conflict of a first thread, for example SW Thread 310a, writing a memory line that is read by a second thread, for example SW Thread 310d.

However, for multiple threads of different processes, such as SW Thread 310a in Process 308a and SW Thread 310e of Process 308j, the data content of memory line with address 0×ff38 may be different for the threads. However, multiple threads of different processes may see the same data content at a particular address if they are sharing a same portion of address space. In one embodiment, hardware computing system 302 incorporates a single processor core 200 configured to process two or more threads. In another embodiment, system 302 includes one or more microprocessors 100.

In general, for a given application, operating system 318 sets up an address space for the application, loads the application's code into memory, sets up a stack for the program, branches to a given location inside the application, and begins execution of the application. Typically, the portion of the operating system 318 that manages such activities is the operating system kernel 312. Kernel 312 may further determine a course of action when insufficient memory is available for the execution of the application. As stated before, an application may be divided into more than one process and system 302 may be running more than one application. Therefore, there may be several processes running in parallel. Kernel 312 may decide at any time which of the simultaneous executing processes should be allocated to the processor(s). Kernel 312 may allow a process to run on a core of a processor, which may have one or more cores, for a predetermined amount of time referred to as a time slice. A scheduler 316 in the operating system 318, which may be within kernel 312, may comprise decision logic for assigning processes to cores. Also, the scheduler 316 may decide the assignment of a particular software thread 310 to a particular hardware thread 314 within system 302 as described further below.

In one embodiment, only one process can execute at any time per processor core, CPU thread, or Hardware Thread. In FIG. 3, Hardware Threads 314a-314g and 314h-314r comprise hardware that can handle the execution of the one or more threads 310 within one of the processes 308. This hardware may be a core, such as core 200, or a subset of circuitry within a core 200 configured to execute multiple threads. Microprocessor 100 may comprise one or more of such cores. The dashed lines in FIG. 3 denote assignments and do not necessarily denote direct physical connections. Thus, for example, Hardware Thread 314a may be assigned for Process 308a. However, later (e.g., after a context switch), Hardware Thread 314a may be assigned for Process 308j.

In one embodiment, an ID is assigned to each of the Hardware Threads 314. This Hardware Thread ID, not shown in FIG. 3, but is further discussed below, is used to assign one of the Hardware Threads 314 to one of the Processes 308 for process execution. A scheduler 316 within kernel 312 may handle this assignment. For example, similar to the above example, a Hardware Thread ID may be used to assign Hardware Thread 314r to Process 308k. This assignment is performed by kernel 312 prior to the execution of any applications.

In one embodiment, system 302 may comprise 4 microprocessors, such as microprocessor 100, wherein each microprocessor may comprise 2 cores, such as cores 200. Then system 302 may be assigned HW Thread IDs 0-7 with IDs 0-1 assigned to the cores of a first microprocessor, IDs 2-3 assigned to the cores of a second microprocessor, etc. HW Thread ID 2, corresponding to one of the two cores in processor 304b, may be represented by Hardware Thread 314r in FIG. 2. As discussed above, assignment of a Hardware Thread ID 2 to Hardware Thread 314r may be performed by kernel 312 prior to the execution of any applications. Later, as applications are being executed and processes are being spawned, processes are assigned to a Hardware Thread for process execution. For the soon-to-be executing process, for example, process 308k, an earlier assignment performed by kernel 312 may have assigned Hardware Thread 314r, with an associated HW Thread ID 2, to handle the process execution. Therefore, a dashed line is shown to symbolically connect Hardware Thread 314r to Process 308k.

Later, a context switch may be requested, perhaps due to an end of a time slice. At such a time, Hardware Thread 314r may be re-assigned to Process 308q. In such a case, data and state information of Process 308k is stored by kernel 312 and Process 308k is removed from Hardware Thread 314r. Data and state information of Process 308q may then be restored to Hardware Thread 314r, and process execution resumes. A predetermined interruption, such as an end of a time slice, may be based upon a predetermined amount of time, such as every 10-15 milliseconds.

Thread migration, or reassignment of threads, may be performed by a scheduler 316 within kernel 312 for load balancing purposes. Thread migration may be challenging due to the difficulty in extracting the state of one thread from other threads within a same process. For example, heap data allocated by a thread may be shared by multiple threads. One solution is to have user data allocated by one thread be used only by that thread and allow data sharing among threads to occur via read-only global variables and fast local message passing via the thread scheduler 316.

Also, a thread stack may contain a large number of pointers, such as function return addresses, frame pointers, and pointer variables, and many of these pointers reference into the stack itself. Therefore, if a thread stack is copied to another processor, all these pointers may need to be updated to point to the new copy of the stack instead of the old copy. However, because the stack layout is determined by the machine architecture and compiler, there may be no simple and portable method by which all these pointers can be identified, much less changed. One solution is to guarantee that the stack will have exactly the same address on the new processor as it did on the old processor. If the stack addresses don't change, then no pointers need to be updated since all references to the original stack's data remain valid on the new processor.

Mechanisms to provide the above mentioned solutions, to ensure that the stack's address remains the same after migration, and to solve other migration issues not specifically mentioned are well known in the art and are contemplated. These mechanisms for migration may apply to both kernel and user-level threads. For example, in one embodiment, threads are scheduled by a migration thread, wherein a migration thread is a high-priority kernel thread assigned on a per microprocessor basis or on a per processor core basis. When the load is unbalanced, a migration thread may migrate threads from a processor core that is carrying a heavy load to one or more processor cores that currently have a light load. The migration thread may be activated based on a timer interrupt to perform active load balancing or when requested by other parts of the kernel.

In another embodiment, scheduling may be performed on a thread-by-thread basis. When a thread is being scheduled to run, the scheduler 316 may verify this thread is able to run on its currently assigned processor, or if this thread needs to migrate to another processor to keep the load balanced across all processors. Regardless of the particular chosen scheduling mechanism, a common characteristic is the scheduler 316 utilizes fixed non-changing descriptions, such as load balancing, of the system to assign and migrate threads, to compute resources. However, the scheduler 316 within kernel 312 of FIG. 3 may also perform assignments by utilizing the dynamic behavior of threads, such as the performance metrics recorded by the hardware in performance monitor 224 of FIG. 2.

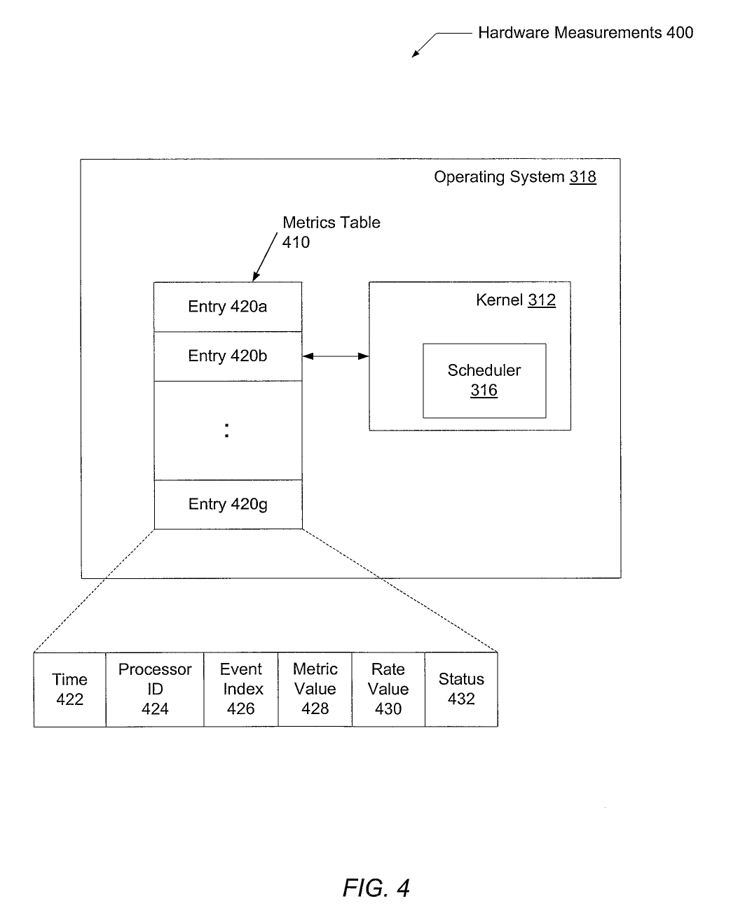

Turning now to FIG. 4, one embodiment of stored hardware measurement data 400 used in an operating system is shown. In one embodiment, operating system 318 may comprise a metrics table 410 for storing data collected from performance monitors 224 in a computing system. This data may be used by the scheduler 316 within the kernel 312 for assigning and reassigning software threads 310 to hardware threads 314. Metrics table 410 may be included in the kernel 312 or outside as shown.

Metrics table 410 may comprise a plurality of entries 420 that may be partitioned by application, by process, by thread, by a type of hardware system component, or other. In one embodiment, each entry 420 comprises a time stamp 422 corresponding to a referenced time the data in the entry is retrieved. A processor identifier (ID) 424 may indicate the corresponding processor in the current system topology that is executing a thread or process that is being measured. A thread or process identifier may accompany the processor ID 424 to provide finer granularity of measurement. Also, rather than have a processor identifier, a system bus, I/O interface, or other may be the hardware component being measured within the system topology. Again, a thread or process identifier may accompany an identifier of a system bus, I/O interface, or other.

An event index 426 may indicate a type of hardware-related event being measured, such as a number of cache hits/misses, a number of pipeline flushes, or other. These events may be particular to an interior design of a computation unit, such as a processor core. The actual measured value may be stored in the metric value field 428. A corresponding rate value 430 may be stored. This value may include a corresponding frequency or percentage measurement. For example, rate value 430 may include a number of cache hits per second, a percentage of cache hits of a total number of cache accesses, or other. This rate value 430 may be determined within a computation unit, such as a processor core, or it may be determined by a library within the operating system 318.

A status field 432 may store a valid bit or enabled bit to indicate the data in the corresponding entry is valid data. For example, a processor core may be configured to disable performance monitoring or choose when to advertise performance data. If a request for measurement data is sent during a time period a computation unit, such as a processor core, is not configured to convey the data, one or more bits within field 432 may indicate this scenario. One or more configurable threshold values corresponding to possible events indicated by the event index 426 may be stored in a separate table. This separate table may be accessed by decision logic within the scheduler 316 to compare to the values stored in the metric value field 428 and rate value 430 during thread assignment/reassignment. Also, one or more flags within the status field 432 may be set/reset by these comparisons.

Although the fields in entries 420 are shown in this particular order, other combinations are possible and other or additional fields may be utilized as well. The bits storing information for the fields 422-432 may or may not be contiguous. Similarly, the arrangement of metrics table 410, a table of programmable thresholds, and decision logic within scheduler 316 for thread assignment/reassignment may use other placements for better design trade-offs.

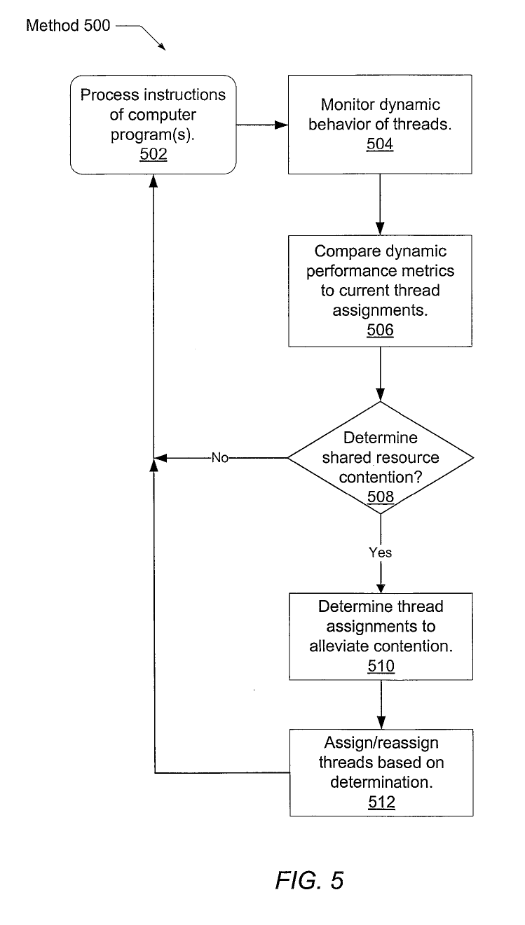

Referring now to FIG. 5, one embodiment of a method 500 for efficient dynamic scheduling of tasks is shown. Method 500 may be modified by those skilled in the art in order to derive alternative embodiments. Also, the steps in this embodiment are shown in sequential order. However, some steps may occur in a different order than shown, some steps may be performed concurrently, some steps may be combined with other steps, and some steps may be absent in another embodiment. In the embodiment shown, source code of one or more software applications is compiled and corresponding threads are assigned to one or more processor cores in block 502. A scheduler 316 within kernel 312 may perform the assignments.

A processor core 200 may fetch instructions of one or more threads assigned to it. These fetched instructions may be decoded and renamed. Renamed instructions are later picked for execution. In block 504, the dynamic behavior of the executing threads may be monitored. The hardware of performance monitor 224 may be utilized for this purpose.

In block 506, the recorded data in performance monitor 224 may be reported to a scheduler 316 within kernel 312. This reporting may occur by the use of an instruction in the ISA, a system call or interrupt, an executing migration thread, hardwired output pins, or other. The recorded data values may be compared to predetermined thresholds by the scheduler 316. Some examples of predetermined thresholds may include a number of floating-point operations, a number of graphics processing operations, a number of cache accesses, a number of cache misses, a power consumption estimate, a number of branch operations, a number of pipeline stalls due to write buffer overflow, or other. The recorded data may be derived from hardware performance counters, watermark indicators, busy bits, dirty bits, trace captures, a power manager, or other. As used herein, a “predetermined threshold” may comprise a threshold which is in some way statically determined (e.g., via direct programmatic instruction) or dynamically determined (e.g., algorithmically determined based upon a current state, detected event(s), prediction, a particular policy, any combination of the foregoing, or otherwise).

In one embodiment, these threshold values may be constant values programmed in the code of the scheduler 316. In another embodiment, these threshold values may be configurable and programmed into the code of kernel 312 by a user and accessed by scheduler 316. Other alternatives are possible and contemplated. If shared resource contention is determined (conditional block 508), then in block 510, the scheduler 316 may determine new assignments based at least in part on alleviating this contention. The scheduler 316 may comprise additional decision-making logic to determine a new assignment that reduces or removes the number of threshold violations. For example, returning again to FIG. 1 and FIG. 2, a microprocessor 100 may comprise two processor cores with the circuitry of core 200. Each core may be configured to execute two threads. Each core may comprise only a single FPU in units 210.

A first thread, arbitrarily named thread1, may be assigned to the first core. At this time, it may not be known that thread1 heavily utilizes a FPU by comprising a high number of floating-point instructions. A second thread, thread2, may be assigned to the second core in order to create minimal potential contention between the two threads due to minimum resource sharing. At this time, it may not be known that thread2 is not an FPU intensive thread.

Later, when a third thread, thread3, is encountered, the scheduler 316 may assign thread3 to the second hardware thread 314 of the first core, since it is the next available computation unit. At this time, it may not be known that thread3 heavily utilizes a FPU by also comprising a high number of floating-point instructions. Now, since both thread1 and thread3 heavily utilize a FPU, resource contention will occur on the single FPU within the first core as the threads execute.

The scheduler 316 may receive measured data values from the hardware in performance monitor 224. In one embodiment, such values may be received at a predetermined time—such as at the end of a time slice or an interrupt generated within a core upon reaching a predetermined event measured by performance monitor 224. Such an event may include the occurrence of a number of cache misses, a number of pipeline stalls, a number of branch operations, or other, exceeding a predetermined threshold. The scheduler 316 may analyze the received measured data and determine utilization of the FPU in the first core exceeds a predetermined threshold, whereas the utilization of the FPU in the second core does not exceed this predetermined threshold.

Further, the scheduler 316 may determine both thread1 and thread3 heavily utilize the FPU in the first core, since both thread1 and thread3 have a count of floating-point operations above a predetermined threshold. Likewise, the scheduler 316 may determine thread2 has a count of floating-point operations far below this predetermined threshold.

Then in block 512, the scheduler 316 and kernel 312 reassign one or more software threads 310 to a different hardware thread 314, which may be located in a different processor core. For example, the scheduler 316 may reassign thread1 from being assigned to the first core to being assigned to the second core. The new assignments based on the dynamic behavior of the active threads may reduce shared resource contention and increase system performance. Then control flow of method 500 returns to block 502.

In the above description, reference is generally made to a microprocessor for purposes of discussion. However, those skilled in the art will appreciate that the method and mechanisms described herein may be applied to any of a variety of types of processing units—whether it be central processing units, graphic processing units, or otherwise. All such alternatives are contemplated. Accordingly, as used herein, a microprocessor may refer to any of these types of processing units. It is noted that the above-described embodiments may comprise software. In such an embodiment, the program instructions that implement the methods and/or mechanisms may be conveyed or stored on a computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A computing system comprising:
one or more microprocessors comprising performance monitoring hardware;
a memory coupled to the one or more microprocessors, wherein the memory stores a program comprising program code; and
an operating system comprising a scheduler, wherein the scheduler is configured to:
assign a plurality of software threads corresponding to the program code to a plurality of computation units;
receive measured data values from the performance monitoring hardware as the one or more microprocessors process the software threads of the program code; and
reassign a first thread assigned from a first computation unit coupled to a first shared resource to a second computation unit coupled to a second shared resource, in response to determining from the measured data values that a first value corresponding to the utilization of the first shared resource exceeds a predetermined threshold and a second value corresponding to the utilization of the second shared resource does not exceed the predetermined threshold.

2. The computing system as recited in claim 1, wherein the scheduler is further configured to determine from the measured data values the first thread utilizes the first shared resource more than any other thread assigned to a computation unit which is also coupled to the first shared resource.

3. The computing system as recited in claim 2, wherein the scheduler is further configured to reassign a second thread from the second computation unit to the first computation unit, in response to determining from the measured data values the second thread utilizes the second shared resource less than any other thread assigned to a computation unit which is also coupled to the second shared resource.

4. The computing system as recited in claim 1, wherein the scheduler is further configured to store configurable predetermined thresholds corresponding to hardware performance metrics used in said determining.

5. The computing system as recited in claim 1, wherein the predetermined thresholds correspond to at least one of the following: a number of floating-point operations, a number of cache accesses, a power consumption estimate, a number of branch operations, or a number of pipeline stalls.

6. The computing system as recited in claim 1, wherein the computation units correspond to at least one of the following: a microprocessor, a processor core, or a hardware thread.

7. The computing system as recited in claim 1, wherein the shared resources correspond to at least one of the following: a branch prediction unit, a cache, a floating-point unit, or an input/output (I/O) device.

8. The computing system as recited in claim 1, wherein said receiving measured data values comprises utilizing at least one of the following: a system call, a processor core interrupt, an instruction, or output pins.

9. A method comprising:
assigning a plurality of software threads to a plurality of computation units;
receiving measured data values from performance monitoring hardware included in one or more microprocessors processing the software threads; and
reassigning a first thread assigned from a first computation unit coupled to a first shared resource to a second computation unit coupled to a second shared resource, in response to determining from the measured data values that a first value corresponding to the utilization of the first shared resource exceeds a predetermined threshold and a second value corresponding to the utilization of the second shared resource does not exceed the predetermined threshold.

10. The method as recited in claim 9, further comprising determining from the measured data values the first thread utilizes the first shared resource more than any other thread assigned to a computation unit which is also coupled to the first shared resource.

11. The method as recited in claim 10, further comprises reassigning a second thread from the second computation unit to the first computation unit, in response to determining from the measured data values the second thread utilizes the second shared resource less than any other thread assigned to a computation unit which is also coupled to the second shared resource.

12. The method as recited in claim 9, further comprising storing configurable predetermined thresholds corresponding to hardware performance metrics used in said determination.

13. The method as recited in claim 9, wherein the predetermined thresholds correspond to at least one of the following: a number of floating-point operations, a number of cache accesses, a power consumption estimate, a number of branch operations, or a number of pipeline stalls.

14. The method as recited in claim 9, wherein the computation units correspond to at least one of the following: a microprocessor, a processor core, or a hardware thread.

15. The method as recited in claim 9, wherein the shared resources correspond to at least one of the following: a branch prediction unit, a cache, a floating-point unit, or an input/output (I/O) device.

16. The method as recited in claim 9, wherein said receiving measured data values comprises utilizing at least one of the following: a system call, a processor core interrupt, an instruction, or output pins.

17. A computer readable storage medium storing program instructions configured to perform dynamic scheduling of threads, wherein the program instructions are executable to:
assign a plurality of software threads to a plurality of computation units;
receive measured data values from performance monitoring hardware included in one or more microprocessors processing the software threads; and
reassign a first thread assigned from a first computation unit coupled to a first shared resource to a second computation unit coupled to a second shared resource, in response to determining from the measured data values that a first value corresponding to the utilization of the first shared resource exceeds a predetermined threshold and a second value corresponding to the utilization of the second shared resource does not exceed the predetermined threshold.

18. The storage medium as recited in claim 17, wherein the program instructions are further executable to determine from the measured data values the first thread utilizes the first shared resource more than any other thread assigned to a computation unit which is also coupled to the first shared resource.

19. The storage medium as recited in claim 18, wherein the program instructions are further executable to reassign a second thread from the second computation unit to the first computation unit, in response to determining from the measured data values the second thread utilizes the second shared resource less than any other thread assigned to a computation unit which is also coupled to the second shared resource.

20. The storage medium as recited in claim 17, wherein the program instructions are further executable to store configurable predetermined thresholds corresponding to hardware performance metrics used in said determination.
